(19) United States
(12) Patent Application Publication
(10) Pub. No.: US 2010/0238287 A1
(43) Pub. Date: Sep. 23, 2010

(54) SYSTEM AND METHOD FOR FRACTIONATION OF A CENTRIFUGED SAMPLE

(75) Inventors: E. James Arking, Hamden, CT (US); Triantafyllos Tafas, Rocky Hill, CT (US)

Correspondence Address: KELLEY DRYE & WARREN LLP, 400 ATLANTIC STREET, 13TH FLOOR, STAMFORD, CT, 06901, US

(73) Assignee: Ikonisys, Inc., New Haven, CT (US)

(21) Appl. No.: 12/791,271

(22) Filed: Jun. 1, 2010

Related U.S. Application Data
(62) Division of application No. 10/815,513, filed on Apr. 1, 2004, now abandoned.

(30) Foreign Application Priority Data
Oct. 4, 2002 (US) PCT/US02/31684

(51) Int. Cl. H04N 7/18; G01N 1/12

(52) U.S. Cl. 348/143; 73/864.63; 348/E07.091

(57) ABSTRACT

The present invention relates generally to a fractionator for collecting at least one of a plurality of segregated components from a segregated sample disposed in a sample tube. The fractionator has a head with a head surface at its forward end. The head may be configured to form a slideable seal with the inside surface of a sample tube. A collection port is disposed forward of the head surface, and a fluid passageway is in fluid communication with the collection port and is configured and arranged to allow fluid transport from the sample tube to a sample receptacle. The fractionator may have a valve in fluid communication with the collection port and may have a valve controller configured and arranged to operate the valve based, at least in part, on the location of the collection port with respect to a sample disposed in the sample tube.

### CROSS-REFERENCE TO RELATED APPLICATION

This application is a divisional continuation application of U.S. patent application Ser. No. 10/815,513, filed Apr. 1, 2004, that claims the benefit of U.S. Provisional Application No. 60/327,336, filed Oct. 4, 2001, and PCT Application No. PCT/US2002/31684, filed Oct. 4, 2002, the disclosures of which are incorporated by reference herein in their entirety.

### FIELD OF THE INVENTION

The present invention relates to the field of fractionation of liquid samples. In particular, the present invention relates to the collection of a selectable component from a segregated biological sample, e.g., centrifugal segregation.

### BACKGROUND OF THE INVENTION

Citation or identification of any references in this Section or any section of this Application shall not be construed that such reference is available as prior art to the present invention.

In many instances, indicators of the state of a subject's health may be determined by analyzing the constituents of the subject's blood. Such diagnostic tests may be performed using the unseparated blood sample or may be performed on a separated component of the blood sample.

The four major components of blood are serum, platelets, white blood cells (WBC), and red blood cells (RBC). Each blood component has a density that differs from the densities of the other blood components and will naturally segregate under the action of gravity. The settling time (the time required to segregate the blood sample into its four major components) may be shortened by spinning the blood sample in a centrifuge wherein the higher centrifugal force created by the centrifuge causes the components in the blood sample to segregate into layers more rapidly than under the action of gravity.

The spun blood sample will exhibit four bands corresponding to the four major components of blood. The component having the lowest density (serum) is segregated to the top layer of the spun blood sample, and the component having the highest density (RBC) sinks to the bottom layer of the spun blood sample. The platelets, having a density between that of the serum and WBC, forms a layer between the serum layer and the WBC layer. Similarly, the WBC, having a density between that of the platelets and RBC, forms a layer between the platelet layer and the RBC layer.

The spun blood sample may also segregate minor blood components that require collection. For example, a maternal blood sample may contain very small amounts of fetal nucleated red blood cells (NRBC). Diagnostic tests performed on the NRBC found in maternal blood samples allow for non-invasive (to the fetus) diagnostic testing to determine the state of health of the fetus without the risk associated with collecting a sample directly from the fetus.

Separation, or fractionation, of the segregated blood sample may be accomplished by a variety of methods such as decanting or suctioning via a pipette. Such techniques are usually adequate for separating the serum and RBC layers, which constitute, in terms of volume, the majority of the blood sample. Decanting or suctioning, however, is not efficient in separating the small volume components, such as the fetal NRBC, from the segregated blood sample. In particular, suctioning tends to draw material from the underlying layer directly under the tip of the pipette thereby diluting and mixing the separated layer with portions of the underlying layer. Furthermore, the pipette tip must be displaced laterally along the layer in order to collect portions of the layer that are far, relative to the diameter of the pipette tip, from the tip. The horizontal movement tends to mix the layers making collection of the segregated component more difficult and time consuming.

U.S. Pat. No. 4,003,834 issued on Jan. 18, 1977 to Coombs discloses a method and apparatus for sequentially separating the segregated components of a blood sample by use of piston displacement. U.S. Pat. No. 5,645,715 issued on Jul. 8, 1997 to Coombs discloses an improved collection tip for the displaceable piston. Both patents are herein collectively referred to as the Coombs patents. In Coombs, a piston is inserted into the centrifuge tube containing the segregated blood sample. The volume displaced by the piston as it moves into the centrifuge tube is removed through axially extending passageways in the piston tip. The diameter of the piston tip is sized to the inner diameter of the centrifuge tube and includes a seal to prevent leakage of the sample between the piston and centrifuge tube. The piston tip has a trumpet shape with the wide end presented to the sample and a narrow end connecting to the axially extending passageway. As the tip is displaced into the centrifuge tube, the segregated liquid is pushed upward and into the axially extending passageway for collection. The trumpet shape of the tip is thought to enhance laminar flow of the segregated sample through the tip and into the passageway while reducing unwanted mixing between the segregated layers of the sample during separation. The trumpet shaped tip presents a large area in direct contact with the sample, and the internal passageways of the tip contribute to the risk of contamination of the sample by the tip. The risk of contamination is further increased if the tip is re-used.

Therefore, there remains a need for a liquid gradient fractionator capable of separating a low volume component from a segregated sample with minimal unwanted mixing between the segregated layers and with minimal risk of contamination. There also remains a need for automating the fractionation process and for providing a portable liquid gradient fractionator.

### SUMMARY OF THE INVENTION

In one aspect, the present invention provides a liquid gradient fractionator for collecting at least one of a plurality of segregated components from a segregated sample disposed in a centrifuge tube, the fractionator having a tip sized to form a slideable seal with an inside surface of the centrifuge tube and a collection port disposed ahead of the tip face, defining a plenum space bounded by the tip face, collection port, and the inner surface of the centrifuge tube, and a fluid passageway in fluid communication with the collection port and capable of allowing fluid transport from the centrifuge tube to a collection receptacle. The ratio of the collection port cross-section to the centrifuge tube cross-section (“port-tube cross-section ratio”) may be selected in the range from 1:10 to 1:1000. The port-tube cross-section ratio may also be selected from the range from 1:25 to 1:100.

In another aspect, the present invention provides an automated liquid gradient fractionation system for collecting at least one of a plurality of segregated components from a segregated sample disposed in a sample tube. The system includes a piston, a collection port, at least one valve in fluid communication with the collection port, and a controller operating the at least one valve based, at least in part, on the location of the collection port in the centrifuged sample. The piston may be sized to form a slideable seal with the inner surface of the sample tube. The collection port may be disposed ahead of the piston face such that the piston face remains isolated from the centrifuged sample.

### BRIEF DESCRIPTION OF THE FIGURES

The present invention may be understood more fully by reference to the following detailed description of the preferred embodiment of the present invention, illustrative examples of specific embodiments of the invention, and the appended figures, in which like references refer to like parts throughout, and in which:

FIG. 1 is a side view of one embodiment of the present invention.

FIGS. 2a and 2b are perspective views of the embodiment shown in FIG. 1 inserted in the sample tube.

FIG. 3 is a schematic view of another embodiment of the present invention.

### DETAILED DESCRIPTION OF THE PREFERRED EMBODIMENT

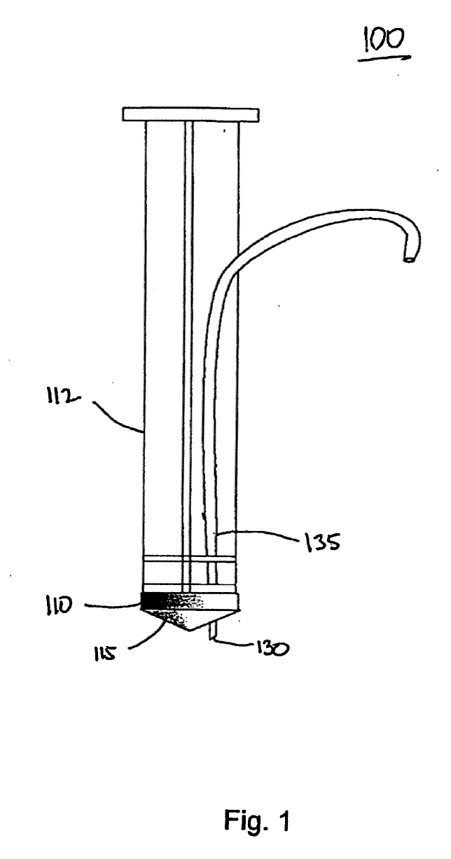

FIG. 1 is a side view of one embodiment of the present invention. Fractionator 100 includes a head 110, a shaft 112 and a fluid passageway 135. In one embodiment, the head 110 may be detached from the shaft 112 thereby enabling re-use of the shaft 112 with single use, disposable heads. In a preferred embodiment, head 110 is permanently attached to the shaft 112 and the combination is disposed of after a single use.

The head 110 may be sized to fit into a sample tube, such as a centrifuge tube. It should be apparent to one of skill in the biological arts that centrifuge tubes are available in a variety of shapes and sizes, and providing a selection of heads sized to fit the selection of centrifuge tubes is within the scope of the invention. As used herein, centrifuge tube may be any straight-walled cylinder, closed at one end, and capable of containing a liquid sample during segregation of the components of the liquid sample under the action of a force field. The closed end may be, for example, flat, rounded or tapered. The head 110 is preferably made of an elastomeric material capable of maintaining a seal between the head and the centrifuge tube as the head is displaced into the tube. A collection port 130 is disposed ahead (i.e., forward) of the head surface 115 and forms the entrance to a fluid passageway 135 that conducts fluid entering the collection port 130 through the head 110 to a collection receptacle (not shown). In a preferred embodiment, the collection port 130 is placed off-center from the center of the head, thereby allowing for a simpler head-shaft mechanical connection. In another embodiment, the collection port 130 is placed at the center of the head surface.

In one embodiment of the present invention, the ratio of the collection port cross-section to the cross-section of the centrifuge tube (port-tube ratio) may be selected from the range of 1:10 to 1:1000. The upper end of the range, corresponding to a very small collection port cross-section relative to the centrifuge tube cross-section, is chosen based on the desired separation rate and unwanted interlayer mixing. A relatively small collection port cross-section reduces the flow rate of the sample through the fluid passageway for a given pressure drop between the gas plenum and the atmospheric pressure at the collection receptacle. The flow rate may be increased by increasing the pressure drop, but increasing the pressure drop may also increase the amount of interlayer mixing, especially when the collection port is near (with a few collection port diameters) a layer-layer interface. If the port-tube ratio is very high, control of the plenum pressure becomes more difficult because a small axial displacement of the head represents a relatively large volume change with respect to the volume through the collection port, thereby creating a large pressure drop and unwanted interlayer mixing. The lower end of the ratio range, corresponding to a relatively large collection port cross-section relative to the centrifuge tube cross-section, is chosen based on the desired accuracy of the separation. If the port-tube ratio is very close to one (collection port cross-section equal to the centrifuge tube cross-section), observation of when the underlying layer enters the fluid passageway becomes very difficult for the operator. Increasing the port-tube ratio allows the operator to more clearly visually identify when the underlying layer enters the fluid passageway. In a preferred embodiment, the port-tube ratio is selected from the range 1:25 to 1:100.

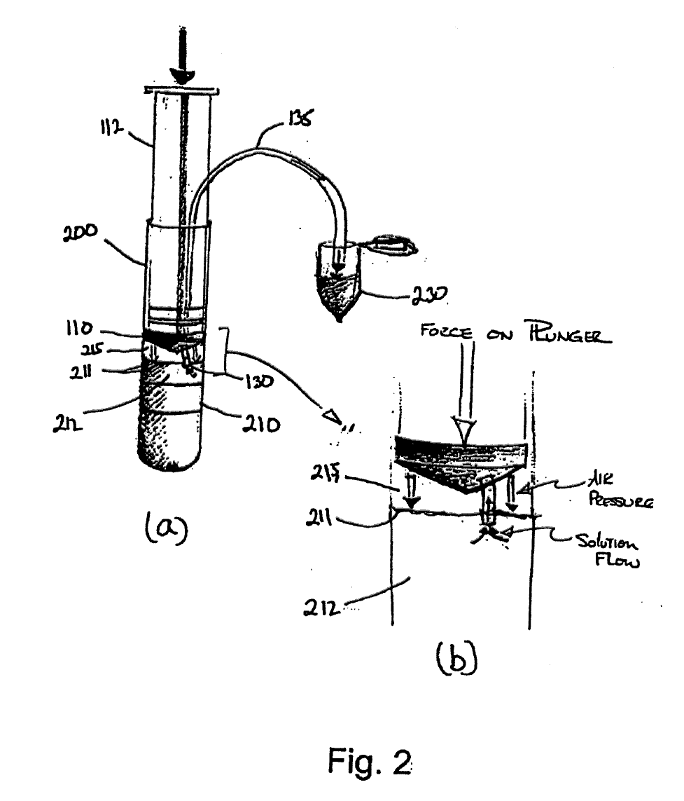

FIGS. 2a and 2b are perspective views illustrating the use of the embodiment shown in FIG. 1 to separate a segregated liquid sample contained in a centrifuge tube. The head 110 is inserted into a centrifuge tube 200 containing a segregated sample 210. The head 110 is advanced into the centrifuge tube 200 by applying an axial force 205 parallel to the longitudinal axis of the shaft 112. In a preferred embodiment, the axial force 205 is applied manually by the operator while holding the centrifuge tube 200. The head 110 is advanced into the centrifuge tube 200 until the collection port 130 contacts the top surface 211 of the top layer 212 of the segregated sample 210. As the head 110 is further displaced into the top layer 212, a gas plenum 215 is formed between the head surface 115 and the top surface 211, and liquid from the top layer 212 is forced into the collection port 130, through the fluid passageway 135 and into a collection receptacle 230. The liquid in the fluid passageway 135 creates a small hydrostatic head such that the pressure in the gas plenum 215 remains above atmospheric pressure. The gas plenum 215 acts to isolate at least part of the head surface 115 from the segregated sample, thereby reducing the risk of contamination of the sample and maintaining a zero shear state on the top surface 211.

As the head 110 is advanced into the centrifuge tube 200, a volume of liquid equal to the volume displaced by the advancing head is forced through the fluid passageway 135 and into the collection receptacle 230. Unlike the situation where suction is applied to draw the liquid in the segregated layer, the displacement of the head appears to reduce the amount of vertical flow from the underlying layer, thereby allowing for a more efficient separation of the segregated layers.

Each segregated layer may be separated into its own collection receptacle 230 by redirecting the fluid passageway 135 into another collection receptacle when the collection port 130 contacts the next segregated layer in the sample. The redirection of the fluid passageway and the observation that the collection port 130 has contacted the next segregated layer is, in the preferred embodiment, performed by the operator, thereby making the fractionation process a simple manual operation that is capable of execution “in the field” and away from a laboratory setting.

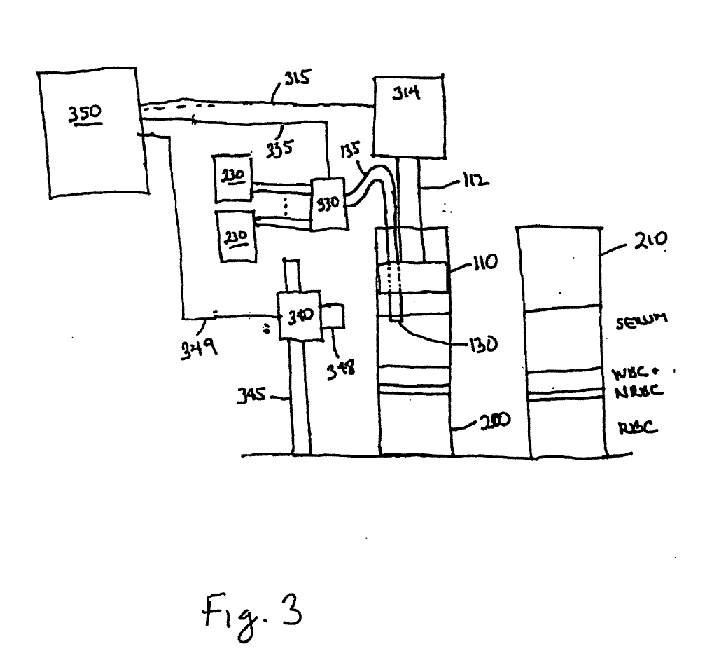

The operations of manually advancing the head, observing the location of the collection port with respect to the segregated layers, and redirecting the fluid passageway may be automated to eliminate operator intervention during the separation process. FIG. 3 is a schematic view of another embodiment of the present invention. Head 110 is advanced into a centrifuge tube 200 containing a sample segregated into the serum, WBC, NRBC, and RBC layers. The head 110 is advanced into the centrifuge tube by a drive unit 314 attached to the shaft 112. The drive unit 314 is controlled by controller 350 via drive signal line 315. The selection of the drive unit 314 may be determined without undue experimentation by one of skill in the mechanical art and requires no further discussion.

As the drive unit 314 advances the head 110 into the centrifuge tube 200, the sample is forced through the collection port 130, through the fluid passageway 135, and into a fluid valve, such as switch 330. The fluid switch 330 directs the sample in the fluid passageway 135 to one of a plurality of collection receptacles 230 based on a command from the controller 350 via switch signal line 335.

The location of the collection port 130 with respect to the segregated layers is determined by a location detection device, such as a video camera 348 mounted on a camera drive unit 340 that allows vertical displacement of the camera along camera base 345. A collection port location signal, such as a video signal, is sent to the controller via video signal line 349.

In a preferred embodiment, controller 350 includes a program executing on a processor. The processor may be a microprocessor or digital signal processor or the like as known to one of skill in the electrical arts. The processor also includes memory for storage of the program and data. The processor also includes input/output devices that enable the controller to control the drive unit 314, camera drive unit 340, and the fluid switch 330, to receive the video signal from the camera 348, to receive program commands from an operator, and to display and/or print information for the operator. In a preferred embodiment, the processor is a personal computer.

The controller determines the location of the collection port relative to the layer-layer interface based on the video signal from the camera. Algorithms for the identification/location of the collection port and interface from the video signal based on light density differences between the layers and collection port are known to one of skill in the art. The controller sends a command to the drive unit to advance the collection port toward the interface, thereby forcing the sample in the topmost layer through the fluid passageway for collection by the collection receptacle. When the controller determines that the collection port has contacted the layer-layer interface, the controller may command the fluid switch to redirect the liquid in the fluid passageway into another collection receptacle. The operation of the fluid switch may be delayed to allow the sample from the topmost layer contained in the fluid passageway to be collected by the collection receptacle before switching to the next collection receptacle. The controller repeats the operations of advancing the collection port and switching the collection receptacles until each layer has been separated.

In another embodiment, the controller may be configured to collect only one of the segregated components. For example, if only the NRBC layer is of interest, the controller may be configured to direct the serum and WBC layer to a waste receptacle, switch to a collection receptacle, collect the NRBC layer, and optionally, switch back to the waste receptacle and collect the RBC layer in the waste receptacle.

In another embodiment, a material transfer line may be incorporated to allow automated transfer of a centrifuge tube containing a segregated sample to the fractionator thereby allowing unattended operation of the fractionator for a plurality of segregated samples.

The invention described herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the present invention.

A number of references are cited herein, the entire disclosures of which are incorporated herein, in their entirety, by reference for all purposes. Further, none of these references, regardless of how characterized above, is admitted as prior to the invention of the subject matter claimed herein.

What is claimed is:

1. A fractionating system for collecting at least a portion of a sample disposed in a sample tube, the fractionating system comprising:
a head having a head surface at a forward end of the head, the head being configured to form a slideable seal with the inside surface of a sample tube;
a collection port disposed forward of the head surface;
a valve in fluid communication with the collection port; and a valve controller configured and arranged to operate the valve based, at least in part, on the location of the collection port with respect to a sample disposed in the sample tube.

2. The fractionating system of claim 1, wherein the valve is configured and arranged to selectively direct the flow of the sample from the sample tube into one or more sample receptacles.

3. The fractionating system of claim 1, further comprising: a drive unit connected to the head, the drive unit being configured and arranged to move the head with respect to the sample tube.

4. The fractionating system of claim 1, further comprising:
a location detection device in operative communication with the valve, the location detection device being capable of producing a collection port location signal based, at least in part, on the position of the collection port with respect to the sample disposed in the sample tube, wherein the operation of the valve is based, at least in part, on the collection port location signal.

5. The fractionating system of claim 4, further comprising:
a drive unit connected to the head, the drive unit being configured and arranged to move the head with respect to the sample tube;
wherein:
the location detection device is in operative communication with the drive unit; and
the operation of the drive unit is based, at least in part, on the collection port location signal.

6. The fractionating system of claim 5, wherein the location detection device comprises a video camera capable of producing the collection port location signal.
